(19) United States
(12) Patent Application Publication
(10) Pub. No.: US 2012/0245738 A1
(43) Pub. Date: Sep. 27, 2012

(54) Minimizing Aggregate Power from HVAC Cooling and IT Equipment in a Data Center

(75) Inventors: Malcolm S. Allen-Ware, Austin, TX (US); John B. Carter, Austin, TX (US); Hendrik F. Hamann, Yorktown Heights, NY (US); Wei Huang, Austin, TX (US); Thomas W. Keller, JR., Austin, TX (US); Juan C. Rubio, Austin, TX (US)

(73) Assignee: International Business Machines Corporation, Armonk, NY (US)

(21) Appl. No.: 13/069,463

(22) Filed: Mar. 23, 2011

(51) Int. Cl. G05D 23/19

(52) U.S. Cl. 700/276

(57) ABSTRACT

A mechanism is provided for minimizing aggregate power from HVAC cooling and IT equipment in a data center. The mechanism selects a high HVAC set point for low-utilization and selects a low HVAC set point for high utilization. For each cooling zone in a data center, the mechanism monitors the average utilization of equipment in the cooling zone and selects the appropriate HVAC set point based on utilization. The mechanism may determine efficiency to determine whether to adjust universal HVAC set points or the HVAC set points for each given cooling zone. That is, the mechanism may dynamically adjust HVAC set points for optimal efficiency. Alternatively, the mechanism may go beyond binary control and compute actual data center efficiency metrics to decide on intermediate set points.

### BACKGROUND

The present application relates generally to an improved data processing apparatus and method and more specifically to mechanisms for minimizing aggregate power from heating, ventilating, and air conditioning (HVAC) and information technology (IT) equipment in a data center.

Heating, ventilating, and air conditioning (HVAC) refers to technology of indoor environmental comfort. HVAC system design is a major sub-discipline of mechanical engineering, based on the principles of thermodynamics, fluid mechanics, and heat transfer. HVAC is important in the design of data centers where large amounts of information technology (IT) equipment perform work and generate heat.

A data center is a facility used to house computer systems and associated components, such as telecommunications and storage systems. A data center generally includes redundant or backup power supplies, redundant data communications connections, environmental controls air conditioning, fire suppression) and security devices.

The physical environment of a data center is rigorously controlled. Air conditioning is used to control the temperature and humidity in the data center. The temperature in a data center will naturally rise because the equipment in the data center converts electrical power to heat as a byproduct of performing work. Unless the heat is removed, the ambient temperature will rise, resulting in electronic equipment malfunction. By controlling the air temperature, the server components at the board level are kept within the manufacturer's specified temperature/humidity range.

Data center equipment, such as servers and storage systems, typically contain fans for controlling temperature. During times of high workload, when the equipment generates excessive heat, the fans turn on to avoid malfunction. However, the fans themselves use power. The HVAC system keeps the data center cool to minimize the amount of time fans are engaged.

During the last few years, energy proportional (EP) servers are starting to play an important role in data centers. Prior to EP servers, the idle power and active power of a server were quite close. Cooling power requirements prior to EP servers was relatively constant, independent of server utilization. However, for EP servers, low utilization results in significantly lower power draw, and less cooling is required for these servers during low utilization.

### SUMMARY

In one illustrative embodiment, a method, in a data processing system, is provided for minimizing aggregate power from cooling and equipment in a data center. The method comprises monitoring average utilization level of equipment in a data center. The method comprises setting heating, ventilation, and air conditioning (HVAC) sets points based on utilization. The method further comprises cooling the data center based on the HVAC set points.

In other illustrative embodiments, a computer program product comprising a computer useable or readable medium having a computer readable program is provided. The computer readable program, when executed on a computing device, causes the computing device to perform various ones, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 depicts a pictorial representation of an example data center in which aspects of the illustrative embodiments may be implemented;

FIG. 2 is a block diagram of an example data processing system in which aspects of the illustrative embodiments may be implemented;

FIG. 3 is a block diagram illustrating a data center in accordance with an illustrative embodiment;

FIG. 4 is a flowchart illustrating operation of an HVAC control system for minimizing aggregate power from HVAC cooling and IT equipment in a data center in accordance with an illustrative embodiment; and

FIG. 5 is a flowchart illustrating operation of an HVAC control system for setting HVAC set points based on efficiency metrics in accordance with an illustrative embodiment.

### DETAILED DESCRIPTION

The illustrative embodiments provide a mechanism for minimizing aggregate power from HVAC cooling and IT equipment in a data center. The mechanism selects a high HVAC set point for low-utilization and selects a low HVAC set point for high utilization. For each cooling zone in a data center, the mechanism monitors the average utilization of equipment in the cooling zone and selects the appropriate HVAC set point based on utilization.

In another embodiment, the mechanism may determine efficiency to determine whether to adjust universal HVAC set points or the HVAC set points for each given cooling zone. That is, the mechanism may dynamically adjust HVAC set points for optimal efficiency.

In another embodiment, the mechanism may go beyond binary control and compute actual data center efficiency metrics to decide on intermediate set points. This embodiment requires more extensive data gathering and sensor networks and is less practical for older data centers or those with heterogeneous servers. This embodiment also requires more detailed thermal maps of cooling zones to identify what the maximum set point can be and still have ambient in-let temperatures within bounds of existing servers.

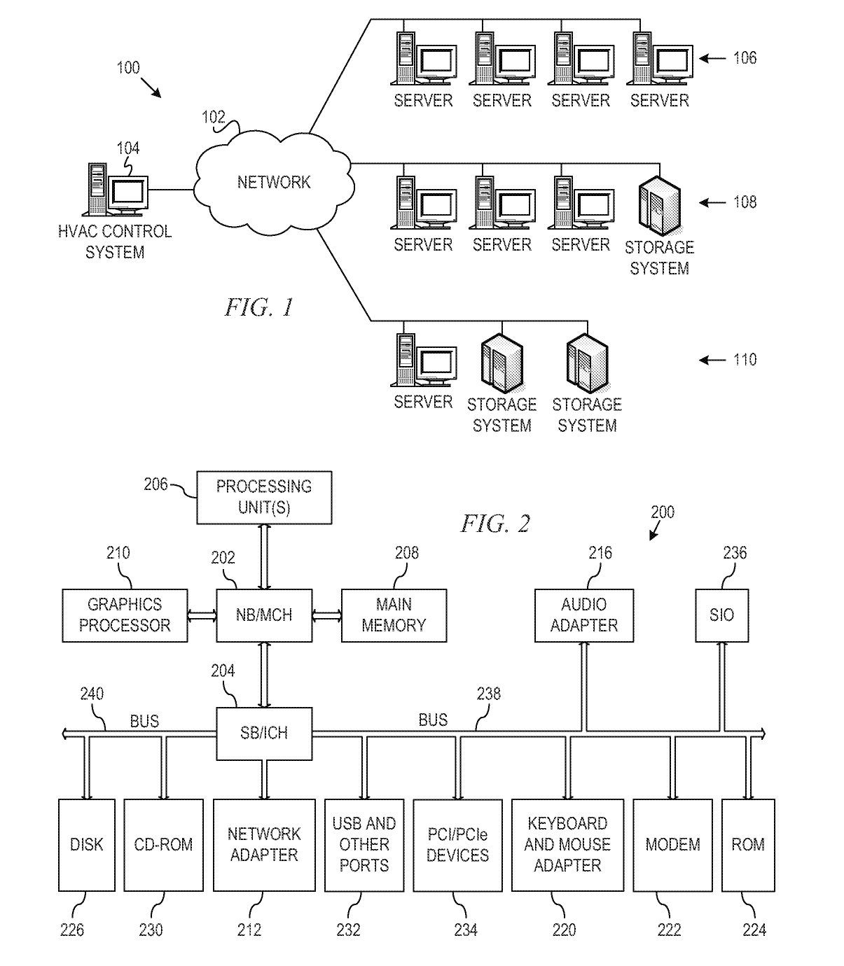

The illustrative embodiments may be utilized in many different types of data processing environments including a distributed data processing environment, a single data processing device, or the like. In order to provide a context for the description of the specific elements and functionality of the illustrative embodiments, FIGS. 1 and 2 are provided hereafter as example environments in which aspects of the illustrative embodiments may be implemented. It should be appreciated that FIGS. 1 and 2 are only examples and are not intended to assert or imply any limitation with regard to the environments in which aspects or embodiments of the present invention may be implemented. Many modifications to the depicted environments may be made without departing from the spirit and scope of the present invention.

FIG. 1 depicts a pictorial representation of an example data center in which aspects of the illustrative embodiments may be implemented. Data center 100 may include a network of computers in which aspects of the illustrative embodiments may be implemented. The data center 100 contains at least one network 102, which is the medium used to provide communication links between various devices and computers connected together within data center 100. The network 102 may include connections, such as wire, wireless communication links, or fiber optic cables.

In the depicted example, HVAC control system 104 and information technology (IT) equipment 106, 108, 110 connect to network 102. In the depicted example, IT equipment 106 comprises a plurality of servers, IT equipment 108 comprises a plurality of servers and a storage system, and IT equipment 110 comprises a server and a plurality of storage systems. Data center 100 may include additional servers, clients, and other devices not shown. In accordance with an illustrative embodiment, IT equipment 106 may be in a first cooling zone, IT equipment 108 may be in a second cooling zone, and IT equipment 110 may be in a third cooling zone.

FIG. 2 is a block diagram of an example data processing system in which aspects of the illustrative embodiments may be implemented. Data processing system 200 is an example of a computer, such as HVAC control system 104 in FIG. 1, in which computer usable code or instructions implementing the processes for illustrative embodiments of the present invention may be located. Alternatively, data processing system 200 may be a server acting as a management entity for a cooling zone in FIG. 1.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240, PCI/PCIe devices may include, for example, Ethernet adapters, add-in cards, and PC cards for notebook computers. PCI uses a card bus controller, while PCIe does not, ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft Windows 7 (Microsoft and Windows are trademarks of Microsoft Corporation in the United States, other countries, or both). An object-oriented programming system, such as the Java programming system, may run in conjunction with the operating system and provides calls to the operating system from Java programs or applications executing on data processing system 200 (Java is a trademark of Oracle and/or its affiliates).

As a server, data processing system 200 may be, for example, an IBM® eServer™ System p® computer system, running the Advanced Interactive Executive (AIX®) operating system or the LINUX operating system (IBM, eServer, System p, and AIX are trademarks of International Business Machines Corporation in the United States, other countries, or both, and LINUX is a registered trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the SNIP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device which is configured with flash memory to provide non-volatile memory for storing operating system files and/or user-generated data, for example. Essentially, data processing system 200 may be any known or later developed data processing system without architectural limitation.

Returning to FIG. 1, some or all of the servers within IT equipment 106, 108, 110 may be energy proportional (EP) servers. Recent benchmarks have focused server vendors on creating improved EP servers. Average utilization levels of typical servers may be 8-10%. At these tow utilization levels, energy proportional servers may run just fine with less cooling in their cooling zones. Many vendors claim that servers can operate safety up to 35-40 C (95-104° F.) ambient.

The desired HVAC set point can be selected to cool the typical low-utilization servers, not the rare highest-utilization server. High-utilization servers can further cool themselves using internal fans. HVAC control system 104 may manage the HVAC set point such that the highest temperature is still reasonable for high-utilization server to cool itself. A high HVAC set point leads to higher chiller efficiency and less HVAC power. The industry is moving toward higher data center ambient temperature for lower DC facility cooling power.

However, a static decision to always run at a higher HVAC set point is not ideal, because during periods of high utilization, IT equipment will likely run fans at higher power. All servers have times of higher utilization where it is a net win to keep the cooling zone at a lower set point versus all these servers running their internal fans harder. Without relatively idle servers, e.g., utilization at 30% or less, it is more efficient to lower the HVAC set point. The HVAC control system should set the HVAC set point fairly low, e.g., 22 C, when server utilization begins to kick up to avoid fans going to significantly higher speeds and drawing a lot more power.

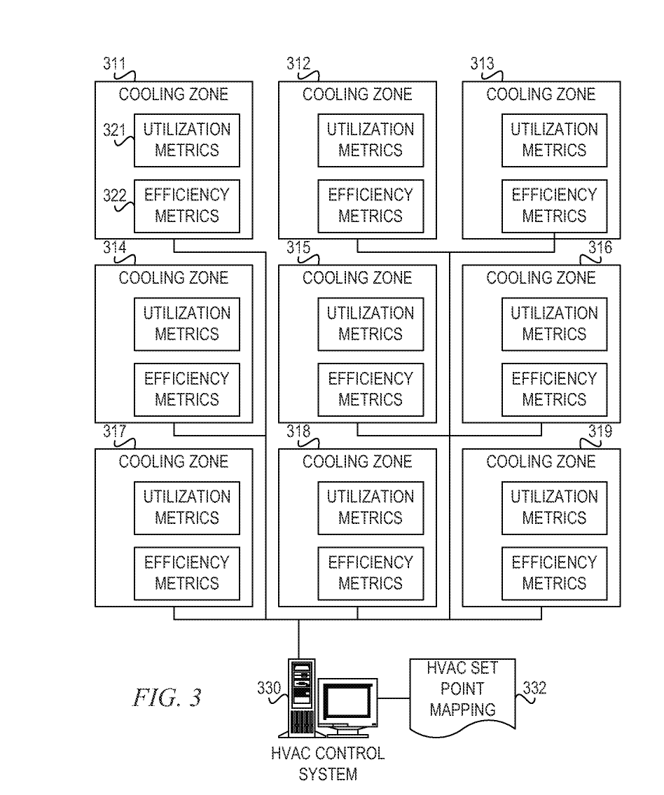

FIG. 3 is a block diagram illustrating a data center in accordance with an illustrative embodiment. The data center is broken up into cooling zones 311-319. Each cooling zone may have a management entity (not shown), which may be embodied in a server in the cooling zone or may be a special purpose computing device. Each cooling zone has associated utilization metrics and efficiency metrics. For example, cooling zone 311 has utilization metrics 321 and efficiency metrics 322.

For storage devices and storage systems, the utilization metrics my comprise utilization measured against peak I/O operations per second (IOPS). Storage Network Industry Association (SNIA) active metric measures power at 100% IOPS and at 25% IOPS so there is focus going forward for energy efficiency at the 25% IOPS level.

HVAC control system 330 collects utilization metrics and efficiency metrics from cooling zones 311-319. In accordance with the illustrative embodiments, the HVAC control system 330 selects a high HVAC set point for low utilization and selects a low HVAC set point for high utilization. For each cooling zone 311-319 in the data center, HVAC control system 330 monitors the average utilization of equipment in the cooling zone based on the utilization metrics and selects the appropriate HVAC set point based on utilization.

In another embodiment, HVAC control system 330 may determine efficiency based on the efficiency metrics to determine whether to adjust universal HVAC set points or the HVAC set points for each given cooling zone. That is, HVAC control system 330 may dynamically adjust HVAC set points for optimal efficiency.

In another embodiment, HVAC control system 330 may go beyond binary control and compute actual data center efficiency metrics to decide on intermediate set points. This embodiment requires more extensive data gathering and sensor networks and is less practical for older data centers or those with heterogeneous servers. This embodiment also requires more detailed thermal maps of cooling zones to identity what the maximum set point can be and still have ambient in-let temperatures within bounds of existing servers. HVAC control system 330 stores an HVAC set point mapping 332 that maps each cooling zone 311-319 to a plurality of HVAC set points for corresponding utilization levels.

As wilt be appreciated by one skilled in the art, the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in any one or more computer readable medium(s) having computer usable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in a baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Computer code embodied on a computer readable medium may be transmitted using any appropriate medium, including but not limited to wireless, wireline, optical fiber cable, radio frequency (RF), etc., or any suitable combination thereof.

Computer program code for carrying out operations for aspects of the present invention may be written in any combination of one or more programming languages, including an object oriented programming language such as Java™, Smalltalk™, C++, or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the tatter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

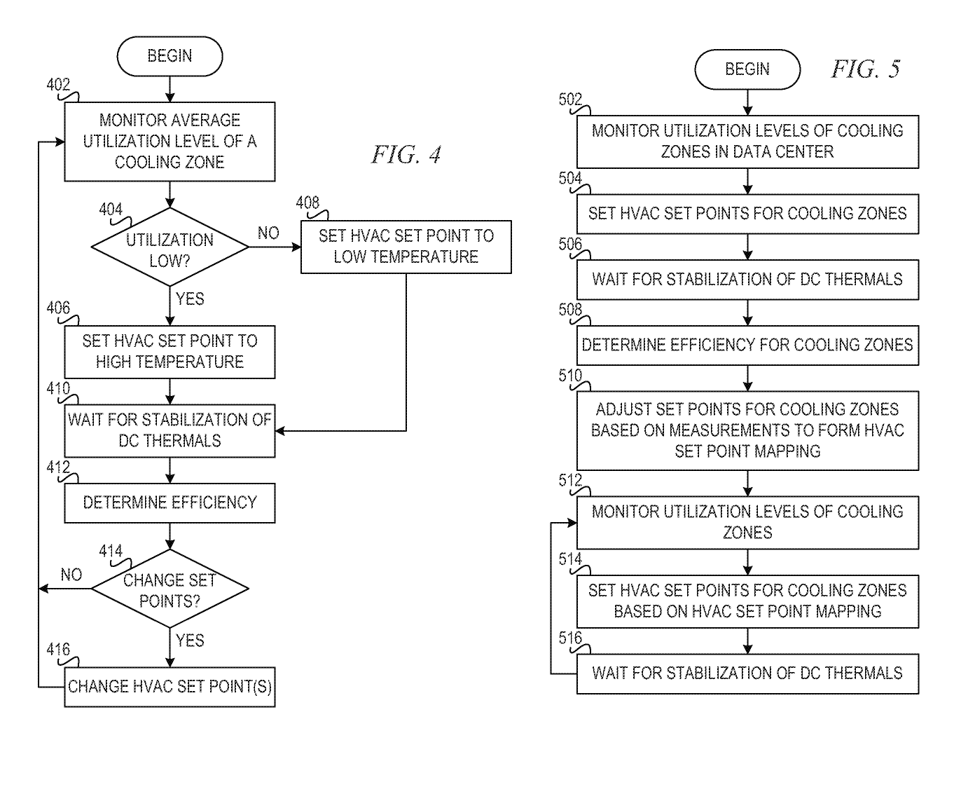

FIG. 4 is a flowchart illustrating operation of an HVAC control system for minimizing aggregate power from HVAC cooling and IT equipment in a data center in accordance with an illustrative embodiment. Operation begins, and the HVAC control system monitors the average utilization level of a cooling zone (block 402). The HVAC control system determines whether utilization is low (block 404). The HVAC control system may determine whether utilization is low by comparing utilization to a threshold. If the HVAC control system determines that utilization is low, the HVAC control system sets the HVAC set point to a high temperature (block 406), and if the HVAC control system determines that utilization is high in block 404, the HVAC control system sets the HVAC set point to a low temperature (block 408). Thereafter, the HVAC control system waits for a stabilization of DC thermals (block 410).

Although not shown in FIG. 4, in one example embodiment, operation may return to block 402 to monitor average utilization level of a cooling zone. The flowchart may repeat for each given cooling zone, selecting the HVAC set point for the cooling zone based on utilization.

As shown in FIG. 4, in accordance with the illustrative embodiment, the HVAC control system determines efficiency of the cooling zone (block 412) and determines whether to change the HVAC set points (block 414). Changing the HVAC set points may comprise changing the low temperature, the high temperature, the low utilization threshold, or any combination thereof. If the HVAC control system determines to change the HVAC set points, the HVAC control system changes the HVAC set point (s) (block 416). Thereafter, or if the HVAC control system does not determine that the HVAC set points are to be changed in block 414, operation returns to block 402 to monitor the average utilization level of the cooling zone.

In one example embodiment, the HVAC control system considers how many of the machines in a cooling zone are energy proportional and adjust the binary limits based on experimenting and measuring results. Thus, actual measurements at the binary limits provide an improvement on when the binary limits should be changed.

FIG. 5 is a flowchart illustrating operation of an HVAC control system for setting HVAC set points based on efficiency metrics in accordance with an illustrative embodiment. Operation begins, and the HVAC control system monitors utilization levels of a plurality of cooling zones in a data center (block 502). The HVAC control system sets HVAC set points for the cooling zones (block 504). The HVAC control system waits for stabilization of DC thermals (block 506).

Then, the HVAC control system determines efficiency for the cooling zones (block 508). The HVAC control system adjusts set points for cooling zones based on measurements to form an HVAC set point mapping (block 510). The HVAC control system monitors utilization levels of the cooling zones (block 512) and sets HVAC set points for cooling zones based on HVAC set point mapping (block 514). The HVAC control system waits for stabilization of DC thermals (block 516). Thereafter, operation returns to block 512 to monitor utilization levels of the cooling zones and repeat setting the HVAC set points for the cooling zones based on the HVAC set point mapping.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, the illustrative embodiments provide a mechanism for minimizing aggregate power from HVAC cooling and IT equipment in a data center. The mechanism selects a high HVAC set point for low-utilization and selects a low HVAC set point for high utilization. For each cooling zone in a data center, the mechanism monitors the average utilization of equipment in the cooling zone and selects the appropriate HVAC set point based on utilization. The mechanism may dynamically adjust HVAC set points for optimal efficiency. The mechanism may go beyond binary control and compute actual data center efficiency metrics to decide on intermediate set points.

As noted above, it should be appreciated that the illustrative embodiments may take the form of an entirely hardware embodiment, an entirely software embodiment or an embodiment containing both hardware and software elements in one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for minimizing aggregate power from cooling and equipment in a data center, the method comprising:
monitoring average utilization level of equipment in a data center;
setting heating, ventilation, and air conditioning (HVAC) set points based on utilization; and
cooling the data center based on the HVAC set points.

2. The method of claim 1, wherein setting HVAC set points based on utilization comprises:
for a given cooling zone, comparing utilization in the given cooling zone to a threshold;
responsive to the comparison resulting in a determination that utilization of the given cooling zone is tow, setting an HVAC set point for the given cooling zone to a high temperature value; and
responsive to the comparison resulting in a determination that utilization of the given cooling zone is high, setting the HVAC set point of the given cooling zone to a low temperature value.

3. The method of claim 2, further comprising:
collecting efficiency metrics for the given cooling zone;
determining whether to change HVAC set points for the given cooling zone based on the efficiency metrics for the given cooling zone; and
responsive to a determination to change set points, adjusting the high temperature value, the low temperature value, or the threshold.

4. The method of claim 1, wherein monitoring average utilization level of equipment comprises:
collecting utilization metrics for cooling zones in the data center.

5. The method of claim 4, wherein setting HVAC set points comprises:
setting a of HVAC set points for each cooling zone within the data center.

6. The method of claim 5, wherein setting HVAC set points further comprises:
collecting efficiency metrics for the cooling zones in the data center;
adjusting the plurality of HVAC set points for the cooling zones based on the efficiency metrics to form an HVAC set point mapping; and
setting the HVAC set points for the cooling zones based on the HVAC set point mapping.

7. A computer program product comprising a computer readable storage medium having a computer readable program stored therein, wherein the computer readable program, when executed on a computing device, causes the computing device to:
monitor average utilization level of equipment in a data center;
set heating, ventilation, and air conditioning (HVAC) set points based on utilization; and
cool the data center based on the HVAC set points.

8. The computer program product of claim 7, wherein setting HVAC set points based on utilization comprises:
for a given cooling zone, comparing utilization in the given cooling zone to a threshold;
responsive to the comparison resulting in a determination that utilization of the given cooling zone is low, setting an HVAC set point for the given cooling zone to a high temperature value; and
responsive to the comparison resulting in a determination that utilization of the given cooling zone is high, setting the HVAC set point of the given cooling zone to a low temperature value.

9. The computer program product of claim 8, wherein the computer readable program further causes the computing device to:
collect efficiency metrics for the given cooling zone;
determine whether to change HVAC set points for the given cooling zone based on the efficiency metrics for the given cooling zone; and
responsive to a determination to change set points, adjust the high temperature value, the low temperature value, or the threshold.

10. The computer program product of claim 7, wherein monitoring average utilization level of equipment comprises:
collecting utilization metrics for cooling zones in the data center.

11. The computer program product of claim 10, wherein setting HVAC set points comprises:
setting a plurality of HVAC set points for each cooling zone within the data center.

12. The computer program product of claim 11, wherein setting HVAC set points further comprises:
collecting efficiency metrics for the cooling zones in the data center;
adjusting the plurality of HVAC set points for the cooling zones based on the efficiency metrics to form an HVAC set point mapping; and
setting the HVAC set points for the cooling zones based on the HVAC set point mapping.

13. The computer program product of claim 7, wherein the computer readable program is stored in a computer readable storage medium in a data processing system and wherein the computer readable program was downloaded over a network from a remote data processing system.

14. The computer program product of claim 7, wherein the computer readable program is stored in a computer readable storage medium in a server data processing system and wherein the computer readable program is downloaded over a network to a remote data processing system for use in a computer readable storage medium with the remote system.

15. An apparatus, comprising:
a processor; and
a memory coupled to the processor, wherein the memory comprises instructions which, when executed by the processor, cause the processor to:
monitor average utilization level of equipment in a data center;
set heating, ventilation, and air conditioning (HVAC) set points based on utilization; and
cool the data center based on the HVAC set points.

16. The apparatus of claim 15, wherein setting HVAC set points based on utilization comprises:
for a given cooling zone, comparing utilization in the given cooling zone to a threshold;
responsive to the comparison resulting in a determination that utilization of the given cooling zone is low, setting an HVAC set point for the given cooling zone to a high temperature value; and
responsive to the comparison resulting in a determination that utilization of the given cooling zone is high, setting the HVAC set point of the given cooling zone to a low temperature value.

17. The apparatus of claim 16, wherein the instructions further cause the processor to:
collect efficiency metrics for the given cooling zone;
determine whether to change HVAC set points for the given cooling zone based on the efficiency metrics for the given cooling zone; and
responsive to a determination to change set points, adjust the high temperature value, the low temperature value, or the threshold.

18. The apparatus of claim 15, wherein monitoring average utilization level of equipment comprises:
collecting utilization metrics for cooling zones in the data center.

19. The apparatus of claim 18, wherein setting HVAC set points comprises:
setting a plurality of HVAC set points for each cooling zone within the data center.

20. The apparatus of claim 19, wherein setting HVAC set points further comprises:
collecting efficiency metrics for the cooling zones in the data center;
adjusting the plurality of HVAC set points for the cooling zones based on the efficiency metrics to form an HVAC set point mapping; and
setting the HVAC set points for the cooling zones based on the HVAC set point mapping.
